(19) United States
(12) Patent Application Publication
(10) Pub. No.: US 2025/0236277 A1
(43) Pub. Date: Jul. 24, 2025

(54) ELECTRO-MECHANICAL BRAKE AND CONTROL METHOD THEREFOR

(71) Applicant: HYUNDAI MOBIS CO., LTD., Seoul (KR)

(72) Inventor: Dong Hwan LIM, Yongin-si (KR)

(73) Assignee: HYUNDAI MOBIS CO., LTD., Seoul (KR)

(21) Appl. No.: 18/978,618

(22) Filed: Dec. 12, 2024

(30) Foreign Application Priority Data
Jan. 23, 2024 (KR) 10-2024-0010159

(51) Int. Cl. B60T 17/22; B60T 13/74; F16D 65/38; F16D 65/46

(52) U.S. Cl. CPC B60T 17/22; B60T 13/746; F16D 65/46; F16D 2065/386

(57) ABSTRACT

A control method for an electro-mechanical brake including a piston configured to push a brake pad toward a wheel disk through driving of a motor, the control method for an electro-mechanical brake including: detecting positions of the piston and current values of the motor while braking is performed; detecting piston position-based estimated braking force values based on the detected positions of the piston; detecting current-based estimated braking force values based on the detected current values of the motor; determining that a state of the brake pad has changed from an initial state to another state when the piston position-based estimated braking force values and the current-based estimated braking force values are different from each other; determining whether a thickness or physical property of the brake pad has changed when determining that the state of the brake pad has changed from the initial state to the other state; setting a new home position by compensating for a preset home position when determining that the thickness of the brake pad has changed; and detecting an actual braking force value based on a movement distance of the piston from the new home position, wherein the home position refers to a position set so that the piston is disposed at the position at the time of non-braking.

### CROSS-REFERENCE TO RELATED APPLICATIONS

The present application claims priority to Patent Application No. 10-2024-0010159, filed on Jan. 23 2024 in Korea, the entire contents of which are incorporated herein by reference.

### TECHNICAL FIELD

The present disclosure relates to an electro-mechanical brake and a control method therefor.

### BACKGROUND

The content described in this section simply provides background information for the present disclosure and does not constitute the related art.

An electro-mechanical brake (EMB) is a brake apparatus that generates a friction braking force. In the electro-mechanical brake, an actuator that is driven by a motor is mounted on a brake caliper. The electro-mechanical brake presses a wheel disk using a motor, a gear box, a screw, a piston, a brake pad, and the like without a medium called a brake fluid.

The electro-mechanical brake has a similar mechanism to an electronic parking brake (EPB), but the electro-mechanical brake is required to have higher reliability and durability since the electro-mechanical brake is a main braking apparatus that is used during traveling. When a driver steps on a pedal, the electro-mechanical brake calculates a required braking force and applies a brake command to each wheel. When the brake command is applied, the motor starts rotating and moving the piston forward, and the piston presses the brake pad. The brake pad presses the wheel disk to generate the braking force.

An electro-mechanical brake (EMB) of the related art measures a braking force using a force sensor and controls the braking force. The force sensor mounted on the electro-mechanical brake is expensive. In addition, the force sensor has a disadvantage that the force sensor does not accurately measure the braking force depending on a position at which the force sensor is mounted. To overcome the disadvantage, a force sensor-less system is used.

The force sensor-less system refers to a system that estimates a braking force without using a force sensor. An electro-mechanical brake to which the force sensor-less system has been applied performs calibration. Here, the calibration refers to a process of setting the electro-mechanical brake. The electro-mechanical brake can perform the calibration to ascertain a braking force value corresponding to a position of a piston. A map in which braking force values corresponding to positions of the piston are indexed is called a force map. With the force map, the electro-mechanical brake can ascertain the braking force without a force sensor and adjust the braking force.

Since a state of the electro-mechanical brake changes with use, for example, brake pads wear out, the calibration must be performed and information of the electro-mechanical brake must be updated each time a vehicle is used. It is preferable to perform the calibration before starting traveling. For example, when a driver opens a door of a vehicle or starts up the vehicle, the calibration can be performed and the force map can be generated.

That is, an electro-mechanical brake using a force sensor-less system may perform calibration to ascertain a current state of the electro-mechanical brake and generate data for estimating a braking force. It is important that the calibration is completed quickly. This is because a driver can travel after the calibration is completed.

The calibration is usually performed only when the driver opens a door of a vehicle or starts up the vehicle. It is not preferable to perform the calibration during traveling. This is because a process of performing the calibration includes a process of driving a motor to move a piston and a brake pad, and a process of generating a braking force. When the calibration is performed regardless of the driver's will during traveling, the driver may feel braking heterogeneity and a traffic accident may occur.

A force map generated when the driver opens the door of the vehicle or starts up the vehicle reflects only a state of the electro-mechanical brake at a point in time when the force map has been generated. The force map cannot reflect in real time the state of the electro-mechanical brake that has changed due to braking during traveling. For example, when the braking is performed during traveling, brake pads may wear out and the stiffness of the brake pads may change. When braking is performed during traveling, the brake pads may expand due to heat or may cool and contract in a cold environment. Thus, a method capable of accurately estimating a braking force without performing additional calibration is required when the state of the electro-mechanical brake is different from the state at the point in time when the force map has been generated due to the braking during traveling. This is because it is not preferable to perform the calibration during traveling, as described above. That is, a method capable of accurately estimating a braking force during driving is required.

### SUMMARY

Therefore, the present disclosure has been made to solve these problems, and a main object of the present disclosure is to provide a method capable of accurately detecting a braking force without performing additional calibration when a state of an electro-mechanical brake changes from a state before traveling due to braking performed during traveling.

The problems to be solved by the present disclosure are not limited to the problems described above, and other problems not described can be clearly understood by those skilled in the art from the description below.

A control method for an electro-mechanical brake including a piston configured to push a brake pad toward a wheel disk through driving of a motor, the control method for an electro-mechanical brake comprising: detecting positions of the piston and current values of the motor while braking is performed; detecting piston position-based estimated braking force values based on the detected positions of the piston; detecting current-based estimated braking force values based on the detected current values of the motor; determining that a state of the brake pad has changed from an initial state to another state when the piston position-based estimated braking force values and the current-based estimated braking force values are different from each other; determining whether a thickness or physical property of the brake pad has changed when determining that the state of the brake pad has changed from the initial state to the other state; setting a new home position by compensating for a preset home position when determining that the thickness of the brake pad has changed; and detecting an actual braking force value based on a movement distance of the piston from the new home position, wherein the home position refers to a position set so that the piston is disposed at the position at the time of non-braking.

An electro-mechanical brake including a piston configured to push a brake pad toward a wheel disk through driving of a motor, the electro-mechanical brake comprising: a position detection unit configured to detect a position of the piston; a current detection unit configured to detect a current of the motor; and a processor configured to calculate an actual braking force value actually generated by the electro-mechanical brake, wherein the processor detects piston position-based estimated braking force values based on the positions of the piston detected by the position detection unit, detects current-based estimated braking force values based on the current values of the motor detected by the current detection unit, determines that a state of the brake pad has changed from an initial state to another state when the piston position-based estimated braking force values and the current-based estimated braking force values are different from each other, determines whether a thickness or physical property of the brake pad has changed when determining that the state of the brake pad has changed from the initial state to the other state, sets a new home position by compensating for a preset home position when determining that the thickness of the brake pad has changed, and calculates an actual braking force value based on a movement distance of the piston from the new home position, wherein the home position refers to a position set so that the piston is disposed at the position at the time of non-braking.

As described above, according to the present embodiment, the electro-mechanical brake has an effect that it is possible to accurately detect the actual braking force value without performing additional calibration when the state of the electro-mechanical brake becomes different from a state before traveling due to braking during traveling.

### BRIEF DESCRIPTION OF THE DRAWINGS

FIG. 1 is a functional block diagram of an electro-mechanical brake according to an embodiment of the present disclosure.

FIG. 2 is a diagram illustrating a braking force generation unit according to an embodiment of the present disclosure.

FIG. 3 is a flowchart illustrating a method of detecting an actual braking force value in an electro-mechanical brake according to an embodiment of the present disclosure.

FIG. 4 is a flowchart illustrating step S150 of FIG. 3 according to an embodiment of the present disclosure.

FIG. 5 is a diagram illustrating data of a first map in a graph according to an embodiment of the present disclosure.

FIGS. 6A and 6B are graphs showing a difference value corresponding to a position of a piston in a plurality of brake pads that are in different states.

FIG. 7 is a flowchart illustrating step S150 of FIG. 3 according to another embodiment of the present disclosure.

FIG. 8 is a flowchart illustrating step S160 of FIG. 3 according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

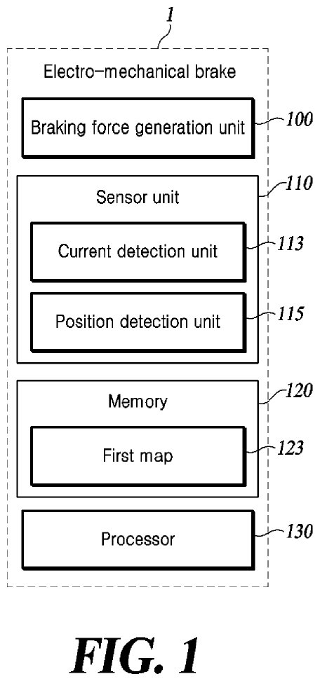

FIG. 1 is a functional block diagram of an electro-mechanical brake according to an embodiment of the present disclosure.

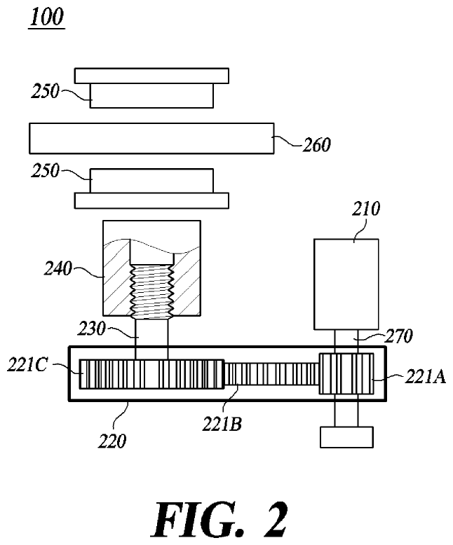

FIG. 2 is a diagram illustrating a braking force generation unit according to an embodiment of the present disclosure.

Referring to FIGS. 1 and 2, an electro-mechanical brake (EMB) 1 includes all or some of a braking force generation unit 100, a sensor unit 110, a memory 120, and a processor 130. The electro-mechanical brake 1 generates a friction braking force. Since the electro-mechanical brake 1 does not use hydraulic pressure, the electro-mechanical brake 1 has a higher response speed and is more environmentally friendly than a hydraulic brake (not shown). The electro-mechanical brake 1 is capable of independent control of each wheel (not shown), thereby providing high braking stability.

When a driver steps on a brake pedal (not shown), the braking force generation unit 100 calculates a required braking force based on a stroke amount of the driver and then generates the braking force. The braking force generation unit 100 may be mounted on a wheel of a vehicle to generate the braking force. The braking force generation unit 100 may be mounted on each wheel of the vehicle. The braking force generation unit 100 is capable of independent braking force generation and independent control for each wheel. The braking force generation unit 100 changes kinetic energy of the vehicle into heat energy using a friction force, and brakes the vehicle.

The braking force generation unit 100 may include all or some of a motor 210, a gear box 220, a power transfer unit 230, a piston 240, a brake pad 250, a rotation shaft 270, and a wheel disk 260. The braking force generation unit 100 is not limited by the disclosure in the drawings. For example, a shape, size, disposition, and the like of the motor 210, the gear box 220, the power transfer unit 230, the piston 240, the brake pad 250, the rotation shaft 270, and the wheel disk 260 are not limited by the disclosure in the drawings.

The motor 210 rotates to move the piston 240. A direction of the piston 240 used in the present specification is defined. Forward movement means that the piston 240 moves toward the wheel disk 260. Backward movement means that the piston 240 moves in an opposite direction of the wheel disk 260.

According to an embodiment, the motor 210 may be a direct current motor (DC Motor), an alternating current motor (AC Motor), an induction motor, a synchronous motor, a step motor, a servo motor, a brushless direct current motor (BLDC motor), a linear motor, a permanent magnet synchronous motor (PMSM), or the like.

One side of the gear box 220 is connected to the motor 210, and the other side of the gear box 220 is connected to the power transfer unit 230. The gear box 220 is configured to transfer the power of the motor 210 to the power transfer unit 230. The gear box 220 includes a plurality of gears 221 therein. In the gear box 220, the plurality of gears 221 are engaged and rotated so that a rotational force can be amplified. A shape and disposition of the gear box 220 are not limited by the drawings. The plurality of gears 221 are not limited to the shape and the number shown in the drawings.

The power transfer unit 230 may receive power from the gear box 220. The power transfer unit 230 may provide the power to the piston 240.

According to one embodiment, the power transfer unit 230 may be a screw shaft. In this case, the piston 240 may be screw coupled to the screw shaft. In this case, when the screw shaft rotates, the screw coupling is connected or disconnected, and the piston 240 moves forward or backward.

The piston 240 moves with the power transferred from the power transfer unit 230.

When the piston 240 moves forward, the piston 240 presses the brake pad 250. The brake pad 250 presses the rotating wheel disk 260 to brake the vehicle.

A pair of brake pads 250 may be provided. The pair of brake pads 250 may be disposed on both sides of the wheel disk 260. The wheel disk 260 is coupled to the wheel of the vehicle and rotates with the wheel. When the piston 240 presses the brake pad 250, the brake pad 250 may press the wheel disk 260. When the brake pad 250 presses the wheel disk 260, the brake pad 250 is compressed and a braking force is generated. As a distance by which the piston 240 moves forward increases, a force with which the brake pad 250 presses the wheel disk 260 increases, and thus, the braking force increases.

The sensor unit 110 may include a current detection unit 113, a position detection unit 115, and the like.

According to one embodiment, the current detection unit 113 may detect a current flowing through the motor 210. For example, a current sensor (not shown) may be included to detect the current flowing through the motor 210. The electro-mechanical brake 1 can control the current flowing through the motor 210 using the current detection unit 113.

According to one embodiment, the position detection unit 115 may detect the position of the piston 240. For example, the position detection unit 115 may include a motor rotation angle sensor (not shown) to detect a rotation angle of the motor 210. As the motor 210 rotates, the piston 240 moves forward or backward. That is, since the position of the piston 240 is determined by the rotation angle of the motor 210, the electro-mechanical brake 1 may detect the position of the piston 240 using the position detection unit 115 including the motor rotation angle sensor.

The processor 130 may detect piston position-based estimated braking force values based on positions of the piston 240 detected by the position detection unit 115.

The processor 130 may detect current-based estimated braking force values based on current values of the motor 210 detected by the current detection unit 113.

When the piston position-based estimated braking force values and the current-based estimated braking force values are different values, the processor 130 may determine that the state of the brake pad 250 has changed from an initial state to another state.

When the processor 130 determines that the state of the brake pad 250 has changed from the initial state to another state, the processor 130 may determine whether a thickness or a physical property of the brake pad 250 have changed.

When a determination is made that the thickness of the brake pad 250 has changed, the processor 130 may set a new home position by compensating for the preset home position.

The processor 130 may detect the actual braking force value based on a movement distance of the piston 240 from the new home position.

A first map 123 is stored in the memory 120. The first map 123 may be a force map indicating a correlation relationship between the position of the piston and the braking force. Detailed description of the first map 123 will be given later.

A state of the electro-mechanical brake 1 used in the present specification is defined. A first state refers to a state of the electro-mechanical brake 1 when traveling and braking have not yet been performed. For example, the first state may be a state of the electro-mechanical brake 1 when electric power is applied to the vehicle due to start-up. For example, the first state may be a state of the electro-mechanical brake 1 when a door of a vehicle of which an engine is turned off opens.

The term initial state used in the present specification has the same meaning as the first state described above. When braking is performed during traveling, the state of the electro-mechanical brake 1 may change from the first state (the initial state) to another state. For example, the brake pad 250 may expand due to heat. For example, the brake pad 250 may contract due to a cold environment. For example, when the brake pad 250 is worn, a physical property may change. That is, the stiffness of the brake pad 250 may change.

Hereinafter, the actual braking force refers to a braking force actually generated by the electro-mechanical brake 1. Since the electro-mechanical brake 1 according to the present disclosure is a force sensor-less system that does not include a force sensor for directly measuring the actual braking force, the actual braking force by the electro-mechanical brake 1 must be calculated based on a movement distance of the piston 240, the position of the piston 240, the current flowing through the motor 210, or the like.

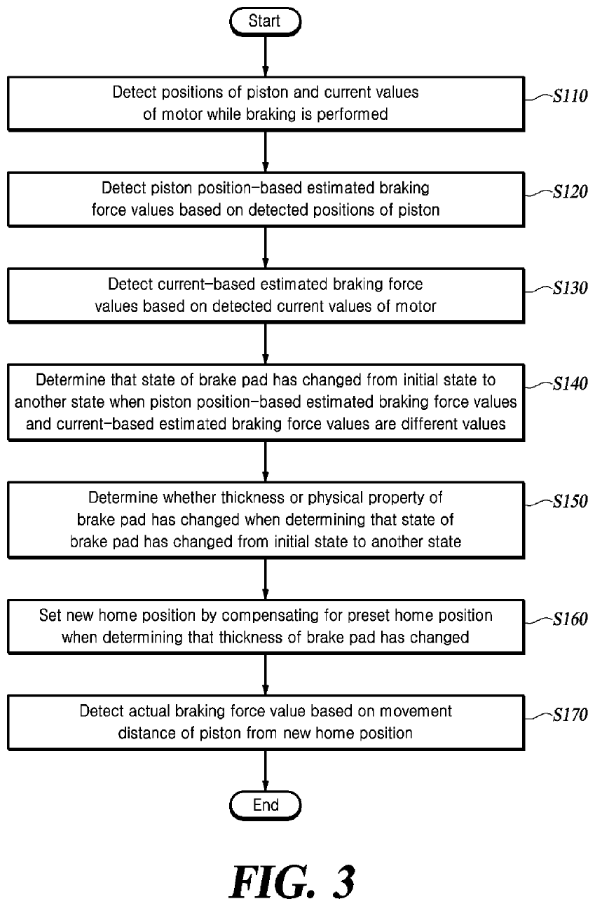

FIG. 3 is a flowchart illustrating a method of detecting an actual braking force value in an electro-mechanical brake according to an embodiment of the present disclosure.

Referring to FIG. 3, the electro-mechanical brake 1 according to the embodiment of the present disclosure may detect the positions of the piston 240 and the current values of the motor 210 while braking is performed (S110).

The electro-mechanical brake 1 may detect the piston position-based estimated braking force values based on the detected positions of the piston 240 (S120). This is because the position of the piston 240 and the braking force of the electro-mechanical brake 1 have a certain correlation relationship. This will be described.

According to one embodiment, the electro-mechanical brake 1 may detect, as the piston position-based estimated braking force values, values that are output when the detected positions of the piston 240 are input to the pre-stored first map 12. Here, the first map 123 may be a map in which braking force values of the electro-mechanical brake corresponding to the positions of the piston 240 in the initial state are indexed. The first map 123 may be created by performing calibration in the initial state (=first state). When the motor 210 is driven, the piston 240 pushes the brake pad 250 toward the wheel disk 260, and when the brake pad 250 comes into contact with the wheel disk 260, the braking force is generated. Thus, the position of the piston 240 when the brake pad 250 comes into contact with the wheel disk 260 is called a contact point. In the electro-mechanical brake 1, the braking force to be generated increases in proportion to the movement distance of the piston 240 from the contact point, and thus, the braking force to be generated can be calculated by detecting the contact point and knowing how much the piston 240 has moved from the contact point. That is, the first map 123 may be generated by converting a correlation relationship between the position of the piston 240 (or the movement distance of the piston) and the generated braking force into data in the initial state.

TABLE 1

| Piston position | Braking force |
|---|---|
| 0.016 | 4588 |
| 0.709 | 7216 |
| 0.789 | 9961 |
| 0.829 | 11468 |
| 0.876 | 13098 |
| 0.923 | 14641 |
| 0.97 | 16295 |
| 1.017 | 17896 |
| 1.063 | 19683 |

Table 1 is an example showing a correlation relationship between the position of the piston 240 and the braking force converted into the data in the first map 123. In step S120, the positions of the piston 240 detected in a situation where actual braking is being performed are input to the pre-stored first map 123, and the braking force values output depending on the input may be detected as the piston position-based estimated braking force values. For example, when the position of the piston 240 is detected as 1.063 and 1.063 is input to the first map 123, 19683 may be detected as the piston position-based estimated braking force value.

The electro-mechanical brake 1 may detect the current-based estimated braking force values based on the detected current values of the motor 210 (S130). In the electro-mechanical brake 1, since a generated braking force increases in proportion to an intensity of the current applied to the motor 210, it is possible to calculate the generated braking force by detecting the current applied to the motor 210.

The electro-mechanical brake 1 may determine that the state of the brake pad 250 has changed from the initial state (=first state) to another state when the piston position-based estimated braking force values and the current-based estimated braking force values are different values (S140).

TABLE 2

| | Piston position-based | Current-based estimated |
|---|---|---|
| Point in time | estimated braking force | braking force |
| 1 | 4588 | 4487 |
| 2 | 7216 | 7362 |
| 3 | 9961 | 9601 |
| 4 | 11468 | 10957 |
| 5 | 13098 | 12172 |
| 6 | 14641 | 13715 |
| 7 | 16295 | 15571 |
| 8 | 17896 | 17010 |
| 9 | 19683 | 19063 |

TABLE 3

| | Piston position-based | Current-based estimated |
|---|---|---|
| Point in time | estimated braking force | braking force |
| 1 | 4588 | 501 |
| 2 | 7216 | 2048 |
| 3 | 9961 | 4024 |
| 4 | 11468 | 4726 |
| 5 | 13098 | 6247 |
| 6 | 14641 | 7790 |
| 7 | 16295 | 9072 |
| 8 | 17896 | 10491 |
| 9 | 19683 | 11745 |

Table 2 shows the piston position-based estimated braking force and the current-based estimated braking force detected on the same point in time when the state of the brake pad 250 is the initial state. It can be seen that the piston position-based estimated braking force values and current-based estimated braking force values in Table 2 are quite similar to each other.

Table 3 shows the piston position-based estimated braking force and the current-based estimated braking force detected on the same point in time when the state of the brake pad 250 is the other state. The piston position-based estimated braking force values and the current-based estimated braking force values in Table 3 are different values, and it can be seen from a comparison with Table 2 that a difference between the values is quite large.

The piston position-based estimated braking forces in Table 2 and Table 3 are output as the same values. That is, the piston position-based estimated braking force does not reflect change in the state of the brake pad 250. This is because the piston position-based estimated braking force is simply the braking force calculated depending on the position of the piston 240. That is, the piston position-based estimated braking force has a different value from the actual braking force value.

The state of the brake pad 250 continuously changes depending on various factors such as wear due to braking, heat generation due to braking, and external temperature. When the state of the brake pad 250 changes from the initial state to another state due to braking during traveling, the first map 123 is not accurately applied to the brake pad 250 in the other state. This is because the first map 123 represents the correlation relationship between the position of the piston and the braking force in the initial state.

The piston position-based estimated braking force values refer to values output by inputting the positions of the detected piston to the first map 123. Therefore, when the state of the brake pad 250 changes from the initial state to the other state, an error is generated between the piston position-based estimated braking force values and the actual braking force value generated by the electro-mechanical brake 1. That is, when the state of the brake pad 250 changes, the piston position-based estimated braking force values are inaccurate since there is a difference from the actual braking force value.

On the other hand, the current-based estimated braking force value is a braking force calculated by measuring the current flowing through the motor 210. Therefore, even when the state of the brake pad 250 changes from the initial state to another state, the current-based estimated braking force value relatively accurately reflects the actual braking force value of the electro-mechanical brake 1. This is because, when the state of the brake pad 250 changes, the measured current value of the motor 210 also changes.

However, when the current flowing through the motor 210 is measured, there are a case where it is difficult to accurately measure the current due to noise. That is, there is a case where the current-based estimated braking force value cannot be calculated due to failing in accurately measuring the current flowing through the motor 210.

Thus, when the state of the brake pad 250 changes from the initial state to another state, the piston position-based estimated braking force values do not reflect the accurate actual braking force value, and the current-based estimated braking force values cannot be calculated sometimes. A method capable of accurately calculating the actual braking force value will be described later in steps S150 to S170.

In summary, when the state of the brake pad 250 is the initial state, both piston position-based estimated braking force values and the current-based estimated braking force values can accurately reflect the actual braking force value. However, when the state of the brake pad 250 changes from the initial state to another state, the piston position-based estimated braking force values do not accurately reflect the actual braking force value, and thus, the current-based estimated braking force values relatively accurately reflecting the actual braking force value, and the piston position-based estimated braking force values represent different values.

That is, When the piston position-based estimated braking force values and the current-based estimated braking force values are different values, a determination may be made that the state of the brake pad 250 has changed from the initial state to another state.

When the electro-mechanical brake 1 determines that the state of the brake pad 250 has changed from the initial state to another state, the electro-mechanical brake 1 can determine whether a thickness (or volume) or a physical property of the brake pad 250 has changed (S150). When the physical property of the brake pad 250 has changed, change in stiffness of the brake pad 250 must be corrected to calculate the actual braking force value. This is because, when the physical property of the brake pad 250 changes, an output braking force value changes even when the piston 240 presses the brake pad 250 with the same force. On the other hand, when the thickness of the brake pad 250 rather than the physical property changes, it is not necessary to correct the change in stiffness. The brake pad 250 may expand or contract due to various causes such as temperature change and wear, to change the volume and thickness thereof. A method of detecting the actual braking force value when the thickness and volume of the brake pad 250 change will be described later.

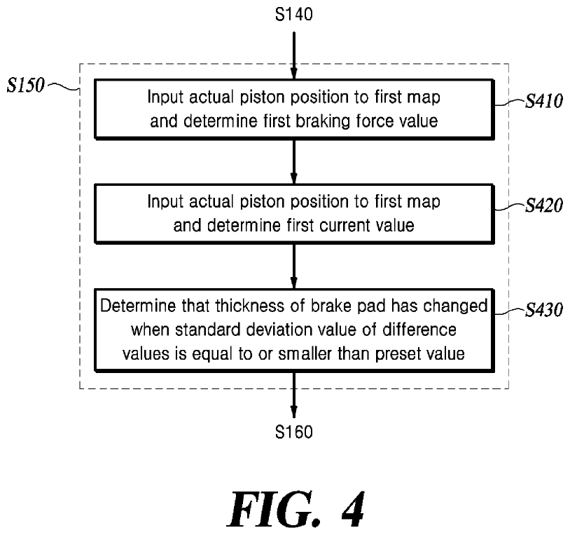

Step S150 according to one embodiment will be described in greater detail using FIGS. 4 to 6.

FIG. 4 is a flowchart illustrating step S150 of FIG. 3 according to an embodiment of the present disclosure.

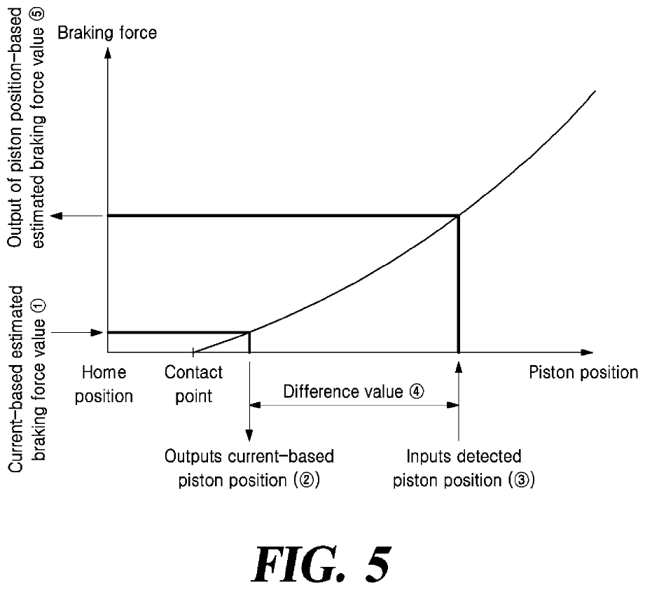

FIG. 5 is a diagram illustrating data of the first map in a graph according to an embodiment of the present disclosure.

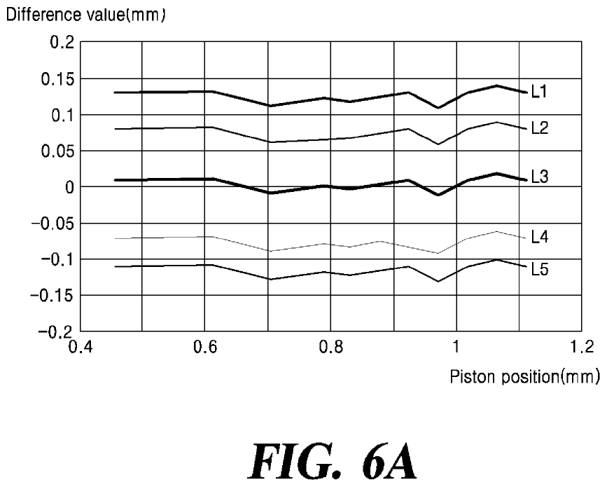

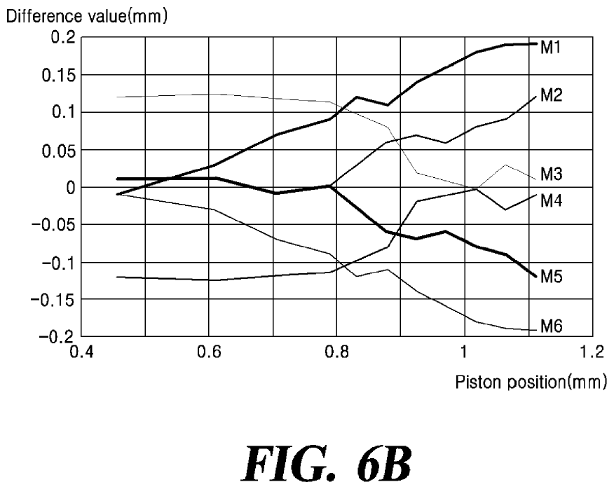

FIGS. 6A and 6B are graphs showing the difference value corresponding to the position of the piston in a plurality of brake pads that are in different states.

Referring to FIGS. 4 to 6, the electro-mechanical brake 1 can determine whether a thickness (or volume) or a physical property of the brake pad 250 has changed. Since the electro-mechanical brake 1 includes the sensor unit 110, the electro-mechanical brake 1 may detect the position of the piston 240 and the current of the motor 210 in real time. As described above, the electro-mechanical brake 1 may detect the piston position-based estimated braking force value when the position of the piston 240 is known. The electro-mechanical brake 1 may detect the current-based estimated braking force value when the current value of the motor 210 is known.

The electro-mechanical brake 1 inputs the current-based estimated braking force values to the first map 123 and outputs current-based piston positions (S410). The electro-mechanical brake 1 can calculate difference values between the detected piston positions and the current-based piston positions (S420). Here, the current-based piston position refers to a position of the piston that is output when the current-based estimated braking force value calculated from the current flowing through the motor 210 is input to the first map 123.

In steps S410 and S420, specifically, referring to FIG. 5, the electro-mechanical brake 1 may input a current-based estimated braking force value \textcircled{1} detected at a first point in time to the first map 123 and output a current-based piston position \textcircled{2} (S410). The electro-mechanical brake 1 may calculate a difference value \textcircled{4} between the piston position \textcircled{3} detected by the sensor unit 110 at the first point in time and the current-based piston position \textcircled{2} (S420).

TABLE 4

| Piston position | Difference value |
|---|---|
| 0.455 | 0.13 |
| 0.61 | 0.132 |
| 0.704 | 0.112 |
| 0.788 | 0.122 |
| 0.83 | 0.118 |
| 0.877 | 0.125 |
| 0.924 | 0.13 |
| 0.971 | 0.11 |
| 1.018 | 0.13 |
| 1.064 | 0.14 |
| 1.111 | 0.13 |

Table 4 shows a difference value \textcircled{4} corresponding to each detected piston position (\textcircled{3}) at a plurality of points in time.

Although only the difference value (\textcircled{4}) at the first point in time is shown in FIG. 5, the electro-mechanical brake 1 can calculate a plurality of difference values for a plurality of points in time in real time since the sensor unit 110 of the electro-mechanical brake 1 detects the current value of the motor and the position of the piston in real time (for example, Table 4).

As will be described later, the difference values can be used when a new home position is set. For reference, the piston position-based estimated braking force value \textcircled{5} in FIG. 5 is a braking force value that is output when the position \textcircled{3} of the piston detected at the first point in time is input to the first map 123.

The electro-mechanical brake 1 may determine that the thickness (or volume) of the brake pad 250 has changed when a variance value of the difference values or a standard deviation value of the difference values is equal to or smaller than a preset value (S430).

Specifically, L1 to L5 shown in FIG. 6A indicate graphs showing five brake pads 250 in different states. M1 to M6 shown in FIG. 6B are graphs showing six brake pads 250 in different states.

While the difference values for the piston positions are evenly distributed in L1 to L5 in FIG. 6A, the difference values for the piston positions are relatively unevenly distributed in M1 to M6 in FIG. 6B. That is, the variance values (or standard deviation values) of M1 to M6 are greater than the variance values (or standard deviation values) of L1 to L5.

When the difference values are evenly distributed with respect to the position of the piston 240 as shown in FIG. 6A, a determination may be made that the thickness of the brake pad 250 rather than the stiffness of the brake pad 250 has changed. In this case, a distance (gap) between the brake pad 250 and the piston 240 can be adjusted by moving the piston 240 forward or backward by change in the thickness of the brake pad 250. Detailed description thereof will be given later.

On the other hand, when the difference values are unevenly distributed with respect to the position of the piston 240 as shown in FIG. 6B, the variance value (or standard deviation value) is greater than the preset value, and thus, a determination may be made that the stiffness of the brake pad 250 has changed. In this case, correction through the forward or backward movement of the piston 240 is impossible.

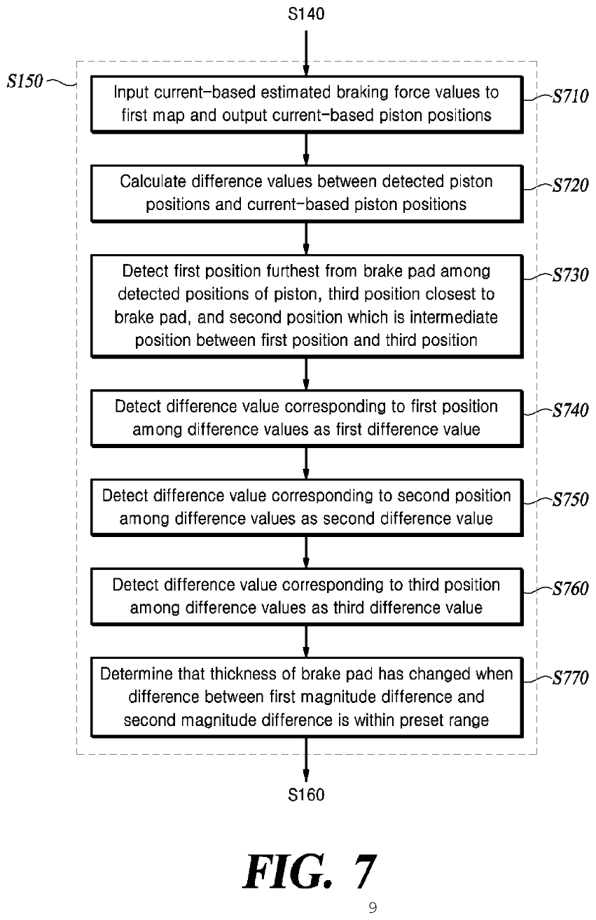

Step S150 according to another embodiment will be described in greater detail using FIG. 7.

FIG. 7 is a flowchart illustrating step S150 of FIG. 3 according to another embodiment of the present disclosure.

Referring to FIG. 7, since steps S710 and S720 of FIG. 7 are the same as steps S410 and S420 of FIG. 4, description of steps S710 and S720 is replaced with the description of steps S410 and S420 described above.

The electro-mechanical brake 1 may detect a first position furthest from the brake pad 250 among the detected positions of the piston, the third position closest the brake pad 250, and a second position which is an intermediate position between the first position and the third position (S730). The electro-mechanical brake 1 may detect the difference value corresponding to the first position among the difference values as a first difference value (S740). The electro-mechanical brake 1 may detect the difference value corresponding to the second position among the difference values as a second difference value (S750). The electro-mechanical brake 1 may detect the difference value corresponding to the third position among the difference values as a third difference value (S760). When a difference between a first magnitude difference and a second magnitude difference is within a preset range, the electro-mechanical brake 1 may determine that the thickness of the brake pad has changed (S770). Here, the first magnitude difference refers to a magnitude difference between the first difference value and the second difference value, and the second magnitude difference refers to a magnitude difference between the second difference value and the third difference value.

For example, in Table 4, the first position is 0.455, the third position is 1.111, and the second position is 0.877 (S730). The first difference value corresponding to the first position is 0.13 (S740), the second difference value corresponding to the second position is 0.125 (S750), and the third difference value corresponding to the third position is 0.13 (S760). The first magnitude difference is 0.05, and the second magnitude difference is 0.05. That is, in the case of Table 4, the first magnitude difference and the second magnitude difference are the same.

Here, a difference between the first magnitude difference of 0.05 and the second magnitude difference of 0.05, is 0. Assuming that the preset range is 0.1, the difference between the first magnitude difference and the second magnitude difference is within the preset range of 0.1, and thus, a determination may be made that the thickness of the brake pad 250 has changed (S770).

When a determination is made that the thickness of the brake pad 250 has changed, the electro-mechanical brake 1 may set a new home position by compensating for the preset home position (S160). When the thickness of the brake pad 250 has changed, an air gap between the piston 240 and the brake pad 250 is adjusted to calculate the actual braking force value. The home position refers to a position set so that the piston 240 is disposed at the position at the time of no-braking. That is, the piston 240 pressing the brake pad 250 at the time of braking returns to the home position at the time of non-braking.

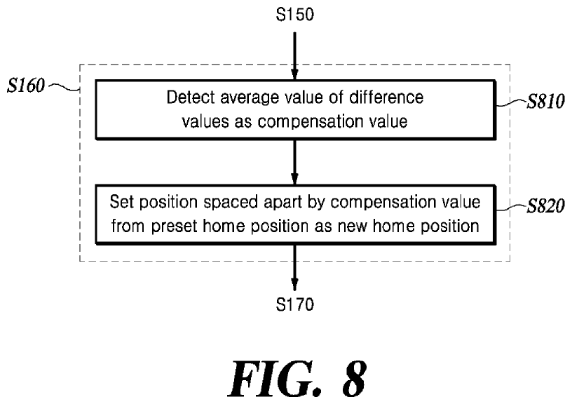

Step S160 will be described in detail using FIG. 8.

FIG. 8 is a flowchart illustrating step S160 of FIG. 3 according to an embodiment of the present disclosure.

Referring to FIG. 8, the electro-mechanical brake 1 detects an average value of the difference values as a compensation value in order to set a new home position (S810). Since the difference value is close to a value of change (increase or decrease amount) in the thickness of the brake pad 250, it is effective to estimate the average value of the difference values as the thickness change value of the brake pad 250. That is, the electro-mechanical brake 1 detects the average value of the difference values as the compensation value.

The electro-mechanical brake 1 may set a position spaced apart by the compensation value from the preset home position as the new home position (S820). When the thickness of the brake pad 250 is different from that in the initial state, the air gap also changes. The air gap refers to a gap from the home position to the brake pad 250.

When a size of the air gap changes due to change in the state of the brake pad 250, the braking force output by the first map 123 cannot accurately reflect the actual braking force unless the size of the air gap is adjusted. This is because the force map such as the first map 123 is set to calculate the braking force value corresponding to the movement distance of the piston 240 from the home position (or contact point), and because the distance by which the piston 240 must actually move from the home position in order to generate the braking force changes when the air gap changes. For example, when the air gap increases, the piston 240 must move by a greater distance from the home position to generate the braking force. For example, when the air gap decreases, the braking force is generated even when the piston 240 moves by a shorter distance from the home position. That is, when the state of the brake pad 250 changes from the initial state to another state (=when the air gap changes), the piston position-based estimated braking force values in step S120 are different from the actual braking force values.

That is, step S820 is a step of compensating for change in the air gap due to change in the thickness of the brake pad 250. Since the compensation value is the thickness change value of the brake pad, an air gap at the new home position has the same size as the air gap at the preset home position when a position spaced apart by the compensation value from the preset home position is set as the new home position.

According to one embodiment, the electro-mechanical brake 1 may be configured to set the new home position only when the compensation value is greater than or equal to a preset value. Specifically, when the compensation value is smaller than the preset value, the preset home position is maintained and the new home position is not set. For example, When the preset value is 0.05 and the compensation value is 0.07, the new home position is set. When the compensation value is 0.02, the new home position is not set.

The electro-mechanical brake 1 may detect the actual braking force value based on a movement distance of the piston 240 from the new home position (S170). Since the new home position is set in step S160, it is possible to detect the actual braking force value by detecting how much the piston 240 has moved from the new home position. When the size of the air gap is adjusted as the new home position is set, the first map 123 can also be used. This is because the air gap satisfies a condition that the first map 123 can be applied.

This is because the first map 123 can output a braking force value corresponding to the movement distance of the piston 240 from the home position.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A control method for an electro-mechanical brake including a piston configured to push a brake pad toward a wheel disk through driving of a motor, the control method for an electro-mechanical brake comprising:
detecting positions of the piston by a position detection unit and current values of the motor by a current detection unit, while braking is performed;
detecting piston position-based estimated braking force values based on the detected positions of the piston using a processor;
detecting current-based estimated braking force values based on the detected current values of the motor using the processor;
determining that a state of the brake pad has changed from an initial state to another state when the piston position-based estimated braking force values and the current-based estimated braking force values are different from each other using the processor;
determining whether a thickness or physical property of the brake pad has changed when determining that the state of the brake pad has changed from the initial state to the other state using the processor;
setting a new home position by compensating for a preset home position when determining that the thickness of the brake pad has changed using the processor; and
detecting an actual braking force value based on a movement distance of the piston from the new home position using the processor, wherein
the home position refers to a position set so that the piston is disposed at the position at the time of non-braking.

2. The control method for an electro-mechanical brake of claim 1, wherein
the detecting of the piston position-based estimated braking force values includes using the position detection unit to input the detected positions of the piston to a pre-stored first map and detect output values as the piston position-based estimated braking force values, and
the pre-stored first map is a map in which braking force values of the electro-mechanical brake corresponding to the positions of the piston in the initial state are indexed.

3. The control method for an electro-mechanical brake of claim 2, wherein
the determining of whether the thickness or physical property of the brake pad has changed includes
using the processor to input the current-based estimated braking force values to the pre-stored first map and output current-based piston positions;
calculate difference values between the detected piston positions and the current-based piston positions; and
determine that the thickness of the brake pad has changed when a standard deviation value of the difference values is equal to or smaller than a preset value.

4. The control method for an electro-mechanical brake of claim 2, wherein
the determining of whether the thickness or physical property of the brake pad has changed includes
using the processor to input the current-based estimated braking force values to the pre-stored first map and output current-based piston positions;
calculate difference values between the detected piston positions and the current-based piston positions; and
detect a first position farthest from the brake pad among the detected positions of the piston, a third position closest to the brake pad, and a second position, the second position being an intermediate position between the first position and the third position;
detect a difference value corresponding to the first position among the difference values as a first difference value;
detect a difference value corresponding to the second position among the difference values as a second difference value;
detect a difference value corresponding to the third position among the difference values as a third difference value; and
determine that the thickness of the brake pad has changed when a difference between a first magnitude difference, the first magnitude difference being a magnitude difference between the first difference value and the second difference value, and a second magnitude difference, the second magnitude difference being a magnitude difference between the second difference value and the third difference value, is within a preset range.

5. The control method for an electro-mechanical brake of claim 3, wherein
the setting of the new home position by compensating for a preset home position includes
using the processor to detect an average value of the difference values as a compensation value; and
set a position spaced apart by the compensation value from the preset home position as the new home position.

6. The control method for an electro-mechanical brake of claim 5, wherein the setting of the new home position by compensating for the preset home position is performed only when the compensation value is equal to or greater than a preset value using the processor.

7. An electro-mechanical brake including a piston configured to push a brake pad toward a wheel disk through driving of a motor, the electro-mechanical brake comprising:
a position detection unit configured to detect a position of the piston;
a current detection unit configured to detect a current of the motor; and
a processor configured to calculate an actual braking force value actually generated by the electro-mechanical brake, wherein
the processor
detects piston position-based estimated braking force values based on the positions of the piston detected by the position detection unit, detects current-based estimated braking force values based on the current values of the motor detected by the current detection unit, determines that a state of the brake pad has changed from an initial state to another state when the piston position-based estimated braking force values and the current-based estimated braking force values are different from each other, determines whether a thickness or physical property of the brake pad has changed when determining that the state of the brake pad has changed from the initial state to the other state, sets a new home position by compensating for a preset home position when determining that the thickness of the brake pad has changed, and calculates an actual braking force value based on a movement distance of the piston from the new home position, wherein
the home position refers to a position set so that the piston is disposed at the position at the time of non-braking.

8. The electro-mechanical brake of claim 7, wherein
the processor inputs the detected positions of the piston to a pre-stored first map and detects output values as the piston position-based estimated braking force values, and
the pre-stored first map is a map in which braking force values of the electro-mechanical brake corresponding to the positions of the piston in the initial state are indexed.

9. The electro-mechanical brake of claim 8, wherein
the processor
inputs the current-based estimated braking force values to the pre-stored first map and outputs current-based piston positions,
calculates difference values between the detected piston positions and the current-based piston positions, and
determines that the thickness of the brake pad has changed when a standard deviation value of the difference values is equal to or smaller than a preset value.

10. The electro-mechanical brake of claim 9, wherein the processor detects an average value of the difference values as a compensation value and sets a position spaced apart by the compensation value from the preset home position as the new home position.
